(19) United States
(12) Patent Application Publication
(10) Pub. No.: US 2011/0039965 A1
(43) Pub. Date: Feb. 17, 2011

(54) RESIN COMPOSITION AND FOAM MOLDED ARTICLE

(75) Inventors: Hiroyoshi Nakajima, Ichihara-shi (JP); Takashi Fuujimoto, Shinagawa-ku (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/739,893

(22) PCT Filed: Oct. 30, 2008
(86) PCT No.: PCT/JP2008/070260

§ 371 Date: Jul. 29, 2010

(30) Foreign Application Priority Data
Oct. 31, 2007 (JP) 2007-283094

(51) Int. Cl. C08L 23/12

(52) U.S. Cl. 521/139; 525/240; 524/536

(57) ABSTRACT

There is a resin composition containing a propylene polymer (A), an ethylene-α-olefin copolymer (B), and organic polymer beads (C), wherein the proportion of the amount of the propylene polymer (A) and the proportion of the amount of the ethylene-α-olefin copolymer (B) relative to the sum total of the amounts of the propylene polymer (A) and the ethylene-α-olefin copolymer (B) are 40 to 95% by mass and 5 to 60% by mass, respectively, the amount of the organic polymer beads (C) for 100 parts by weight in total of the propylene polymer (A) and the ethylene-α-olefin copolymer (B) is 0.1 to 20 parts by weight, and the density of the ethylene-α-olefin copolymer (B) is 0.85 to 0.89 g/cm³.

### TECHNICAL FIELD

The present invention relates to resin compositions and foam molded articles made thereof.

### BACKGROUND ART

Polypropylene has been used widely in a molding field because it is excellent in mechanical properties, chemical resistance, and so on and therefore it is very useful.

JP 2001-316510 discloses a copolymer of propylene and α,ω-diene produced by using a metallocene supported catalyst, a polypropylene-based resin composition containing the copolymer and a foaming agent, a foamed article obtained by heating, melting, kneading, and foam molding the composition, and a foam molded article obtained by molding the foamed article.

JP 8-225689 A discloses a composition obtained by kneading crosslinked polymer beads into a polypropylene-based resin, and a stretched film made thereof.

However, the polypropylene-based resin composition disclosed in JP 2001-316510 does not necessarily have enough foaming property and, therefore, it was difficult to obtain a foamed article with a high expansion ratio or a foamed article having a densely foamed cell structure from this resin composition. Moreover, the polypropylene-based resin composition disclosed in JP 8-225689 A was developed in order to solve a problem of blocking of an extrusion formed product (specifically film) and therefore it has not been used for the production of a foamed article by injection molding.

### DISCLOSURE OF THE INVENTION

Objects of the present invention include to provide a resin composition from which a foam molded article having a uniform cell structure and being excellent in minuteness of foamed cells and thereby provide a foam molded article having a uniform cell structure and being excellent in minuteness of foamed cells.

In a first aspect, the present invention provides a resin composition containing a propylene polymer (A), an ethylene-α-olefin copolymer (B), and organic polymer beads (B), wherein the proportion of the amount of the propylene polymer (A) and the proportion of the amount of the ethylene-α-olefin copolymer (B) relative to the sum total of the amounts of the propylene polymer (A) and the ethylene-α-olefin copolymer (B) are 40 to 95% by mass and 5 to 60% by mass, respectively, the amount of the organic polymer beads (C) for 100 parts by weight in total of the propylene polymer (A) and the ethylene-α-olefin copolymer (B) is 0.1 to 20 parts by weight, and the density of the ethylene-α-olefin copolymer (B) is 0.85 to 0.89 g/cm³.

In a second aspect, the present invention provides a foam molded article formed of the resin composition.

### BRIEF DESCRIPTION OF THE DRAWINGS

FIG. 1 is a schematic perspective view of a foam molded article produced as one embodiment of the present invention. Sign 1 represents an injection gate contact portion, sign 2 represents a portion 10 cm away from an injection gate (portion at which a cross section of the foamed article was evaluated, and sign 3 represents a foam molded article.

FIG. 2 is a diagram illustrating the cell condition of a cross section of the foam molded article produced in Example 1.

FIG. 3 is a diagram illustrating the cell condition of a cross section of the foam molded article produced in Example 2.

FIG. 4 is a diagram illustrating the cell condition of a cross section of the foam molded article produced in Example 3.

FIG. 5 is a diagram illustrating the cell condition of a cross section of the foam molded article produced in Example 4.

FIG. 6 is a diagram illustrating the cell condition of a cross section of the foam molded article produced in Example 5.

FIG. 7 is a diagram illustrating the cell condition of a cross section of the foam molded article produced in Example 6.

FIG. 8 is a diagram illustrating the cell condition of a cross section of the foam molded article produced in Example 7.

FIG. 9 is a diagram illustrating the cell condition of a cross section of the foam molded article produced in Comparative Example 1.

### MODE FOR CARRYING OUT THE INVENTION

The resin composition of the present invention is characterized by containing a propylene polymer (A), an ethylene-α-olefin copolymer (B), and organic polymer beads (B), wherein the proportion of the amount of the propylene polymer (A) and the proportion of the amount of the ethylene-α-olefin copolymer (B) relative to the sum total of the amounts of the propylene polymer (A) and the ethylene-α-olefin copolymer (B) are 40 to 95% by mass and 5 to 60% by mass, respectively, the amount of the organic polymer beads (C) for 100 parts by weight in total of the propylene polymer (A) and the ethylene-α-olefin copolymer (B) is 0.1 to 20 parts by weight, and the density of the ethylene-α-olefin copolymer (B) is 0.85 to 0.89 g/cm³.

### <Propylene Polymer (A)>

The resin composition of the present invention contains a propylene polymer (A). In the present invention, the propylene polymer (A) refers to a propylene homopolymer, a propylene-ethylene copolymer, a propylene-α-olefin copolymer, and a propylene-ethylene-α-olefin copolymer. Among these, a propylene homopolymer and/or a propylene-ethylene copolymer is preferable, and a combination of a propylene homopolymer and a propylene-ethylene copolymer is more preferable.

Examples of the propylene-ethylene copolymer include a propylene-ethylene random copolymer and a propylene-ethylene block copolymer. The propylene-ethylene block copolymer is a polymeric mixture composed of a propylene homopolymer component and a propylene-ethylene random copolymer component.

Examples of the propylene-α-olefin copolymer include a propylene-α-olefin random copolymer and a propylene-α-olefin block copolymer. The propylene-α-olefin block copolymer is a polymeric mixture composed of a propylene homopolymer component and a propylene-α-olefin random copolymer component.

Examples of the propylene-ethylene-α-olefin copolymer include a propylene-ethylene-α-olefin random copolymer or a propylene-ethylene-α-olefin block copolymer. The propylene-ethylene-α-olefin block copolymer is a polymeric mixture composed of a propylene homopolymer component and a propylene-ethylene-α-olefin random copolymer component.

Examples of both the α-olefin in the propylene-α-olefin copolymer and the α-olefin in the propylene-ethylene-α-olefin copolymer include α-olefins having 4 to 20 carbon atoms, specifically, 1-butene, 1-pentene, 1-hexene, 1-octene, and 1-decene. Two or more polymers may be used together as the propylene polymer (A).

From the viewpoint of rigidity, heat resistance or hardness, the propylene polymer (A) is preferably a propylene homopolymer and a propylene-ethylene block copolymer.

The isotactic pentad fraction, as measured by ¹³C-NMR, of a propylene homopolymer preferably is 0.95 or more, and more preferably is 0.98 or more.

The isotactic pentad fraction, as measured by ¹³C-NMR, of the propylene homopolymer component of a propylene-ethylene block copolymer preferably is 0.95 or more, and more preferably is 0.98 or more. The isotactic pentad fraction is a fraction of propylene monomer units which are present at the center of an isotactic chain in the form of a pentad unit in the polypropylene molecular chain, in other words, a fraction of propylene monomer units present at the center of a chain in which five propylene monomer units are meso-bonded successively (this chain is henceforth referred to as mmmm) in the polypropylene molecular chain. The method for measuring the isotactic pentad fraction is the method disclosed by A. Zambelli et al. in Macromolecules 6, 925 (1973), namely, a method in which the measurement is performed by using ¹³C-NMR. NMR absorption peaks are assigned in accordance with the disclosure of Macromolecules, 8, 687 (1975). Specifically, the isotactic pentad fraction is a ratio of the mmmm peak area to the absorption peak area in the methyl carbon ranges observed in a ¹³C-NMR spectrum. According to this method, the isotactic pentad fraction of an NPL standard substance, CRM No. M19-14 Polypropylene PP/MWD/2 available from NATIONAL PHYSICAL LABORATORY, GB. was measured to be 0.944.

The intrinsic viscosity, as measured in a Tetralin solvent of 135° C., of the propylene-ethylene block copolymer as the propylene polymer (A) preferably is 0.1 to 5 dl/g, and more preferably is 0.1 to 3 dl/g.

The intrinsic viscosity, as measured in a Tetralin solvent of 135° C., of the propylene homopolymer component constituting the propylene-ethylene block copolymer (henceforth, referred to also as [η]_{P}) preferably is 0.1 to 5 dl/g, and more preferably is 0.1 to 3 dl/g.

Moreover, the intrinsic viscosity, as measured in a Tetralin solvent of 135° C., of the propylene-ethylene random copolymer component constituting the propylene-ethylene block copolymer (henceforth, referred to also as [η]_{EP}) preferably is 1.0 to 10 dl/g, more preferably is 3 to 8 dl/g, and even more preferably is 4 to 6 dl/g.

The propylene-ethylene random copolymer component content of the propylene-ethylene block copolymer preferably is 10 to 60% by mass, and more preferably is 10 to 40% by mass.

The content of ethylene in the propylene-ethylene random copolymer component constituting the propylene-ethylene block copolymer preferably is 20 to 65% by mass, and more preferably is 25 to 50% by mass.

Preferably, the molecular weight distribution (this may be expressed as Q value or Mw/Mn), as determined by gel permeation chromatography (GPC), of a propylene homopolymer, that of a propylene homopolymer component of a propylene-ethylene block copolymer and that of a propylene-ethylene random copolymer component of a propylene-ethylene block copolymer are respectively 3 to 7.

The melt flow rate (henceforth abbreviated as MFR), as measured at 230° C. under a load of 2.16 kgf in accordance with JIS K7210, of the propylene homopolymer preferably is 0.1 to 500 g/10 min, and more preferably is 1 to 400 g/10 min.

The MFR of the propylene-ethylene block copolymer, as measured at 230° C. under a load of 2.16 kgf in accordance with JIS K7210, is preferably 0.1 to 200 g/10 min, and more preferably 5 to 150 g/10 min.

The propylene polymer (A) can be produced by using a conventional polymerization catalyst and a conventional polymerization method. Examples of such a polymerization catalyst to be used in the production of the propylene polymer (A) include catalyst systems composed of (1) a solid catalyst component containing magnesium, titanium, halogen and an electron donor as essential components, (2) an organoaluminum compound, and (3) an electron donating component. This catalyst can be prepared by, for example, the methods disclosed in JP 1-319508 A, JP 7-216017 A, and JP 10-212319 A. Examples of the polymerization method to be used for the production of the propylene polymer (A) include bulk polymerization, solution polymerization, slurry polymerization, and vapor phase polymerization. Such polymerization methods may be conducted either in a batch system or in a continuous system and may be combined appropriately. The method for producing the propylene-ethylene block copolymer preferably is a method that is performed by using a polymerization apparatus including at least two polymerization vessels arranged in series, in which method, in the presence of the aforementioned catalyst system composed of (1) a solid catalyst component, (2) an organoaluminum compound and (3) an electron donating component, a propylene homopolymer is produced by homopolymerizing propylene in a polymerization vessel, then the propylene homopolymer produced is transferred to the next polymerization vessel, and subsequently a propylene-ethylene random copolymer component is formed by copolymerizing propylene and ethylene in the presence of the propylene homopolymer.

The amounts of (1) the solid catalyst component, (2) the organoaluminum compound and (3) the electron donating component which can be used in the above-mentioned method and the method for feeding the catalyst components into polymerization vessels may be determined appropriately.

The polymerization temperature preferably is −30 to 300° C., and more preferably is 20 to 180° C. The polymerization pressure preferably is normal pressure to 10 MPa, and more preferably is 0.2 to 5 MPa. As a molecular weight regulator, hydrogen may be used, for example.

In the production of the propylene polymer (A), preliminary polymerization may be carried out prior to main polymerization. An example of the method of the preliminary polymerization is a method in which preliminary polymerization is carried out in a slurry state using a solvent by feeding a small amount of propylene in the presence of a solid catalyst component and an organoaluminum compound.

### <Ethylene-α-Olefin Polymer (B)>

The resin composition of the present invention contains an ethylene-α-olefin copolymer (B). The resin composition of the present invention may contain one kind of ethylene-α-olefin copolymer or may contain two or more kinds of ethylene-α-olefin copolymers as the ethylene-α-olefin copolymer (B).

From the viewpoint of the uniformity and the minuteness of the cell structure to be formed by foam molding of a resin composition, the density of the ethylene-α-olefin copolymer (B) is 0.85 to 0.89 g/cm³. It preferably is 0.85 to 0.88 g/cm³, and more preferably is 0.86 to 0.88 g/cm³.

The ethylene content of the ethylene-α-olefin copolymer (B) is preferably from 20 to 95% by mass, and more preferably from 30 to 90% by mass. The α-olefin content is preferably from 5 to 80% by mass, and more preferably from 10 to 70% by mass.

The MFR of the ethylene-α-olefin copolymer (B), as measured at 190° C. under a load of 2.16 kgf in accordance with JIS K7210, is preferably 1 to 50 g/10 min, more preferably 5 to 50 g/10 min, and even more preferably 10 to 40 g/10 min.

Examples of the α-olefin in the ethylene-α-olefin copolymer (B) include α-olefins having 4 to 20 carbon atoms, and specifically include 1-butene, 1-pentene, 1-hexene, 4-methyl-1-pentene, 1-heptene, 1-octene, 1-decene, 1-dodecene, 1-tetradecene, 1-hexadecene, and 1-eicocene. The ethylene-α-olefin copolymer (B) may contain one kind of α-olefin and also may contain two or more kinds of α-olefins. Preferable α-olefins include α-olefins having from 4 to 12 carbon atoms, such as 1-butene, 1-hexene and 1-octene.

The ethylene-α-olefin copolymer (B) can be produced by polymerizing prescribed monomers by slurry polymerization, solution polymerization, bulk polymerization, vapor phase polymerization, or the like using a metallocene catalyst.

Examples of such a metallocene catalyst include the metallocene catalysts disclosed in JP 3-163088 A, JP 4-268307 A, JP 9-12790 A, JP 9-87313, JP 11-80233 A, and WO 96/13529.

A preferable example of the method for producing the ethylene-α-olefin copolymer (B) using a metallocene catalyst is the method disclosed in EP 1211287 A.

### <Proportions of (A) and (B)>

From the viewpoint of balance in the mechanical properties of a foam molded article to be obtained from a resin composition, in the resin composition of the present invention, the proportion of the amount of the propylene polymer (A) and the proportion of the amount of the ethylene-α-olefin copolymer (B) relative to the total amount of the propylene polymer (A) and the ethylene-α-olefin copolymer (B) are 40 to 95% by mass and 5 to 60% by mass, respectively.

### <Organic Polymer Beads (C)>

The resin composition of the present invention contains organic polymer beads (C). The organic polymer beads (C) are usually one or more kinds of beads selected from beads of an optionally-crosslinked organic polymer and beads of an optionally-crosslinked siloxane-based polymer having one or more organic groups. The organic polymer beads (C) are preferably crosslinked organic polymer beads.

Beads of an organic polymer as the organic polymer beads (C) can be obtained by, for example, polymerizing an organic monomer by using a conventional method, such as emulsion polymerization, dispersion polymerization, suspension polymerization, soap-free polymerization method, and seed polymerization. Examples of organic monomers which can be used for the production of the organic polymer beads include (meth)acrylic monomers and styrene-based monomers. Specific examples of the (meth)acrylic monomers include acrylic acid; esters of acrylic acid, such as methyl acrylate, ethyl acrylate, and butyl acrylate; methacrylic acid; ester of methacrylic acid, such as methyl methacrylate, ethyl methacrylate, and butyl methacrylate. Specific examples of the styrene-based monomers include styrene; styrene derivatives, such as methylstyrene, ethylstyrene, butylstyrene, and propylstyrene. Examples of other monomers which can be used for the production of the organic polymer beads include polymerizable vinyl monomers, such as vinyl acetate, vinyl chloride, vinylidene chloride, acrylonitrile, and methacrylonitrile. Among these monomer, (meth)acrylic monomers and styrene-based monomers are preferable. For the production of the organic polymer beads, only one kind of monomer may be used or two or more kinds of monomer may be used.

For the polymerization of an organic monomer for the production of the organic polymer beads (C), a crosslinking agent is preferably used together. The cross-linking agent may be any radically polymerizable monomer containing two or more vinyl groups. Example of such monomers include divinylbenzene, ethylene glycol diacrylate, ethylene glycol dimethacrylate, trimethylolpropane triacrylate, trimethylolpropane trimethacrylate, pentaerythritol tetraacrylate, and pentaerythritol tetramethacrylate. Such crosslinking agents may be used singly or two or more of them may be used together.

As the organic polymer beads (C), siloxane-based polymer beads having one or more organic groups may be used. The siloxane-based polymer beads are beads which are made of silicone rubber or silicone resin and which are in a solid state at normal temperature.

Siloxane-based polymer beads applicable as the organic polymer beads (C) each have one or more organic groups. Examples of such organic groups include an alkyl group, an alkenyl group, an alkynyl group, an aryl group, an arylated alkyl group, an acyl group, an alkoxycarbonyl group, an aryloxycarbonyl group, and a hydrocarbon ring group.

A siloxane-based polymer is produced mainly by hydrolysis and condensation of an organochlorosilane. For example, a siloxane-based polymer can be obtained by hydrolyzing and condensing an organochlorosilane typified by dimethyldichlorosilane, diphenyldichlorosilane, phenylmethylchlorosilicane, methyltrichlorosilane, and phenyltrichlorosilane. For the production of a siloxane-based polymer, one kind of an organochlorosilan may be used singly or two or more kinds of organochlorosilanes may be used in combination. A siloxane-based polymer can be obtained also by hydrolyzing and condensing an organochlorosilane and tetrachlorosilicane.

Moreover, crosslinked siloxane-based polymer beads can be obtained by crosslinking those siloxane-based polymers with peroxides, such as benzoyl peroxide, peroxy-2,4-dichlorobenzoyl, peroxy-p-chlorobenzoyl, dicumyl peroxide, peroxy-di-tert-butyl, and 2,5-dimethyl-2,5-di-(tert-butylperoxy)hexane, or by introducing silanol groups to ends of siloxane-based polymers and then condensation-crosslinking them with alkoxysilane.

Moreover, the organic polymer beads (C) may be porous polymer beads. The organic polymer beads (C) are preferably crosslinked polymethyl methacrylate polymer beads, crosslinked siloxane-based polymer beads, or crosslinked polystyrene polymer beads, more preferably crosslinked polymethyl methacrylate polymer beads or crosslinked siloxane-based polymer beads, and particularly preferably crosslinked polymethyl methacrylate polymer beads.

From the viewpoint of the uniformity and the minuteness of the cell structure to be formed by foam molding of a resin composition, the content of the organic polymer beads (C) contained in the resin composition of the present invention is 0.1 to 20 parts by mass, preferably 0.1 to 10 parts by mass, and more preferably from 0.1 to 5 parts by mass relative to 100 parts by mass in total of the propylene polymer (A) and the ethylene-α-olefin copolymer (B).

The weight average particle diameter of the organic polymer beads (C) is preferably 0.01 to 20 μm, more preferably 0.1 to 10 μm, and even more preferably 0.1 to 6 μm. The shape of the polymer beads may be a spherical shape, a spheroidal shape, a crushed shape, and so on.

### <Inorganic Filler (D)>

It is preferable that the resin composition of the present invention further contains an inorganic filler (D). Examples of the inorganic filler (D) include carbon fiber, metal fiber, glass beads, mica, calcium carbonate, potassium titanate whisker, talc, bentonite, smectite, mica, sepiolite, wollastonite, allophane, imogolite, fibrous magnesium oxysulfate, barium sulfate, and glass flakes. Talc or fibrous magnesium oxysulfate are preferred, and talc is more preferred. As the inorganic filler (D), one kind of inorganic filler may be used or two or more kinds of inorganic fillers may be used in combination. Beads of an optionally-crosslinked siloxane-based polymer having one or more organic groups, which are included by the organic polymer beads (C), are not included by the inorganic filler (D).

The average particle diameter of the inorganic filler (D) is preferably 0.01 to 50 μm, more preferably 0.1 to 30 μm, and even more preferably 0.1 to 5 μm. The average particle diameter of the inorganic filler (D) means a 50% equivalent particle diameter D50 which is determined from an integral distribution curve by the sub-sieve method which is produced by measuring a suspension of the inorganic filler (D) in a dispersing medium, such as water and alcohol, by means of a centrifugal sedimentation type particle size distribution analyzer.

A fibrous filler preferably has an average fiber length, as measured by electron microscopic observation, of 5 μm or more, more preferably 5 to 30 μm, and even more preferably 10 to 20 μm. The average fiber diameter is preferably 0.2 to 1.5 μm, and more preferably 0.3 to 1.0 μm. The average aspect ratio of a fibrous filler is preferably 10 or more, more preferably 10 to 30, and even more preferably 12 to 25. The average fiber diameter, the average fiber length, and the average aspect ratio of a fibrous filler can be determined by randomly selecting 50 or more fibrous fillers in an image resulting from a scanning electron microscope (SEM) observation, subsequently measuring fiber diameters, fiber lengths or aspect ratios, and then calculating an average. The aspect ratio is the ratio of the fiber length to the fiber diameter.

The inorganic filler (D) may be used without being subjected to any treatment or alternatively may be used after being subjected to treatment of its surface with a conventional agent, such as a silane coupling agent, a titanium coupling agent, a higher fatty acid, a higher fatty ester, a higher fatty amide, a salt of a higher fatty acid, or other surfactant, in order to improve the interfacial adhesion strength with the resin composition or improve the dispersibility of the inorganic filler in the resin composition.

The content of the inorganic filler (D) in the resin composition of the present invention is preferably 0.1 to 60 parts by mass, preferably 1 to 30 parts by mass, and more preferably 1 to 10 parts by mass, relative to 100 parts by mass in total of the propylene polymer (A) and the ethylene-α-olefin copolymer (B).

From the viewpoint of the fluidity of a resin composition and the prevention of the occurrence of burr at the time of foam molding, the melt flow rate, as measured at 230° C. under a load of 2.16 kgf in accordance with JIS K7210, of the resin composition of the present invention is preferably 40 to 200 g/10 min, more preferably 40 to 150 g/10 min, and even more preferably 40 to 120 g/10 min.

### <Additives>

The resin composition of the present invention may contain an additive as necessary. There are no particular limitations with the additives which can be used for the present invention. There may be used conventional additives, examples of which include neutralizing agents, antioxidants, light-resisting agents, UV absorbers, copper inhibitors, lubricants, processing aids, plasticizers, dispersing agents, antiblocking agents, antistatic agents, nucleating agents, flame retardants, foam inhibitors, crosslinking agents, colorants, and pigments.

The foam molded article of the present invention is a foam molded article formed of the resin composition of the present invention.

There are no particular limitations with the method for producing the foam molded article of the present invention, but the method preferably has a step of preparing the resin composition of the present invention (preparation step) and a step of foam molding the resin composition (foaming step).

The step of preparing the resin composition of the present invention (preparation step) preferably has a step of preliminarily mixing prescribed amounts of components uniformly by a tumbler or the like to obtain a preliminary mixture, and a step of melt-kneading the obtained preliminary mixture.

The step of foam molding the resin composition (foaming step) preferably has a step of mixing the resin composition obtained by performing the preparation step and a foaming agent to obtain a foaming agent-containing resin composition, and a step of foam molding the foaming agent-containing resin composition.

The foaming agent to be used for the present invention is not particularly restricted and conventional chemical foaming agents and conventional physical foaming agents can be used. The added amount of the foaming agent is preferably 0.1 to 10 parts by mass, and more preferably 0.2 to 8 parts by mass relative to 100 parts by mass of the resin composition of the present invention.

The chemical foaming agent may be either an inorganic compound or an organic compound, and two or more compounds may be used together. Examples of the inorganic compound include hydrogen carbonates, such as sodium hydrogen carbonate. Examples of the organic compound include polycarboxylic acids, such as citric acid, and azo compounds, such as azodicarbonamide (ADCA).

For the present invention, it is preferable to use a physical foaming agent. Examples of the physical foaming agent include inert gas, such as nitrogen and carbon dioxide, and volatile organic compounds. In particular, it is preferable to use carbon dioxide, nitrogen, or a mixture thereof. Two or more kinds of physical foaming agents may be used together, and a chemical foaming agent and a physical foaming agent may be used in combination.

In use of a physical foaming agent, it is preferable to mix the physical foaming agent in a supercritical state with a resin composition in a molten state. Since a physical foaming agent in a supercritical state is high in solubility in a resin and can be diffused uniformly in a molten resin composition in a short time, it is possible to obtain a foam molded article having a high expansion ratio and having a uniform foamed cell structure.

The step of mixing a physical foaming agent to a resin composition in a molten state may be a step of pouring a physical foaming agent into a nozzle or a cylinder of an injection molding apparatus.

Specific examples of the step of foam molding the resin composition of the present invention include a step using a conventional method, such as injection foam molding, press foam molding, extrusion foam molding, and stampable foam molding.

### Examples

The present invention is described in more detail below with reference to Examples and Comparative Example, but the invention is not limited thereto.

In Examples or Comparative Example were used polymers, organic polymer beads, and inorganic fillers given below. MFR was measured at 230° C. under a load of 2.16 kgf in accordance with JIS K7210 unless otherwise stated.

### (1) Propylene-Ethylene Block Copolymer (A-1)

It was produced by vapor phase polymerization using the solid catalyst component disclosed in JP 7-216017 A.

MFR: 31.7 g/10 min

Intrinsic viscosity of the entire portion of the propylene-ethylene block copolymer, [η]_{T}: 1.6 dl/g

Intrinsic viscosity of the propylene homopolymer portion, [η]_{P}: 0.93 dl/g

Ratio of the propylene-ethylene random copolymer portion to the entire portion of the copolymer: 20% by mass

Intrinsic viscosity of the propylene-ethylene random copolymer portion, [η]_{EP}: 4.5 dl/g

Ethylene unit content of the propylene-ethylene random copolymer portion: 36% by mass

### (2) Propylene Homopolymer (A-2)

Commercial name: U501E1 (produced by Sumitomo Chemical Co., Ltd.)

MFR: 120 g/10 min

### (3) Propylene Homopolymer (A-3)

It was produced by vapor phase polymerization using the solid catalyst component disclosed in JP 7-216017 A.

MFR: 300 g/10 min

### (4) Ethylene-Butene Copolymer Rubber (B)

Commercial name: CX5505 (produced by Sumitomo Chemical Co., Ltd.)

Density: 0.878 g/cm³

MFR (measured at 190° C. under a load of 2.16 kgf in accordance with JIS K7210): 14 g/10 min

### (5) Organic Polymer Beads (C)

### (C-1) Crosslinked Polymethyl Methacrylate Polymer Beads

Commercial name: EPOSTAR MA1002 (produced by NIPPON SHOKUBAI Co., Ltd.)

Particle diameter: 2.0 μm

### (C-2) Crosslinked Polymethyl Methacrylate Polymer Beads

Commercial name: Techpolymer MBX-5 (produced by Sekisui Plastics Co., Ltd.)

Particle diameter: 5.7 μm

### (C-3) Crosslinked Siloxane-Based Polymer Beads

Commercial name: XC99-A8808 (produced by Momentive Performance Materials Inc.)

Particle diameter: 0.75 μm

### (C-4) Crosslinked Siloxane-Based Polymer Beads

Commercial name: TOSPEARL 120 (produced by Momentive Performance Materials Inc.)

Particle diameter: 2.0 μm

### (C-5) Crosslinked Polystyrene Polymer Beads

Commercial name: SX-130H (produced by Soken Chemical & Engineering Co., Ltd.)

Particle diameter: 1.3 μm

### (C-6) Crosslinked Polymethyl Methacrylate Polymer Beads

Commercial name: GM-1005-MA (produced by GANZ CHEMICAL CO., LTD.)

Particle diameter: 10 μm

### (C-7) Porous Crosslinked Polymethyl Methacrylate Polymer Beads

Commercial name: GM-1005-10 (produced by GANZ CHEMICAL CO., LTD.)

Particle diameter: 10 μm

### Examples 1 to 7, Comparative Example 1

Prescribed amounts of the components given in Table 1 were preliminarily mixed with a tumbler uniformly. Then, the obtained preliminary mixture was kneaded by using a twin screw kneading extruder (TEX44SS 30BW-2V, manufactured by The Japan Steel Works, Ltd.) at an extrusion rate of 30 to 50 kg/hr, a screw speed of 300 rpm, under vent suction, and the obtained kneadate was extruded at an extrusion rate of 30 to 50 kg/hr. Thus, resin composition pellets were produced.

Using the pellets, injection foam molding was conducted by the use of an injection molding machine ES2550/400HL-MuCell (clamping force=400 tons) manufactured by ENGEL. Nitrogen in a supercritical state was used as a foaming agent.

For the injection molding was used a mold with a cavity having a shape corresponding to a molded article whose schematic perspective view is shown in FIG. 1 and whose approximate dimensions are 290 mm×370 mm×45 mm (height). The basic cavity clearance (initial board thickness) of the cavity in its mold-closed state was 1.5 mm (locally 1.6 mm), and the gate structure of the mold was a direct gate.

The cylinder temperature and the mold temperature were set to 250° C. and 50° C., respectively. After closing the mold, injection of the resin composition containing the foaming agent was started. After completely injection-filling the mold cavity with the resin composition, a cavity wall surface of a movable mold was retracted by 2.0 mm to enlarge the cavity volume, thereby foaming the resin composition. The foamed resin composition was cooled to solidify completely, yielding a foam molded article, which was evaluated at its site 100 mm away from the injection gate.

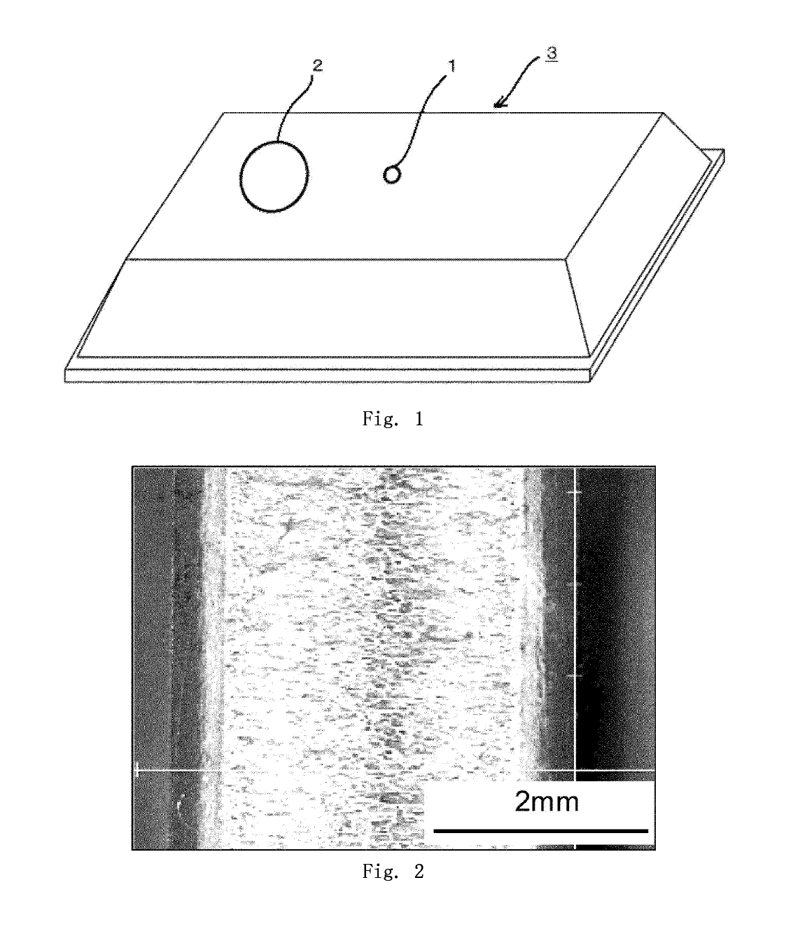

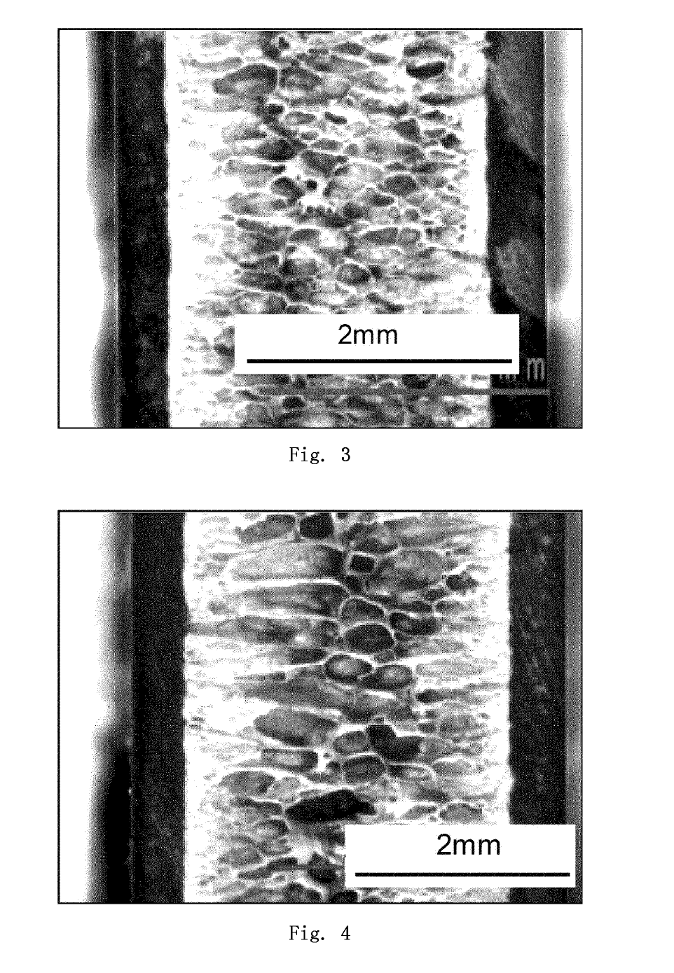

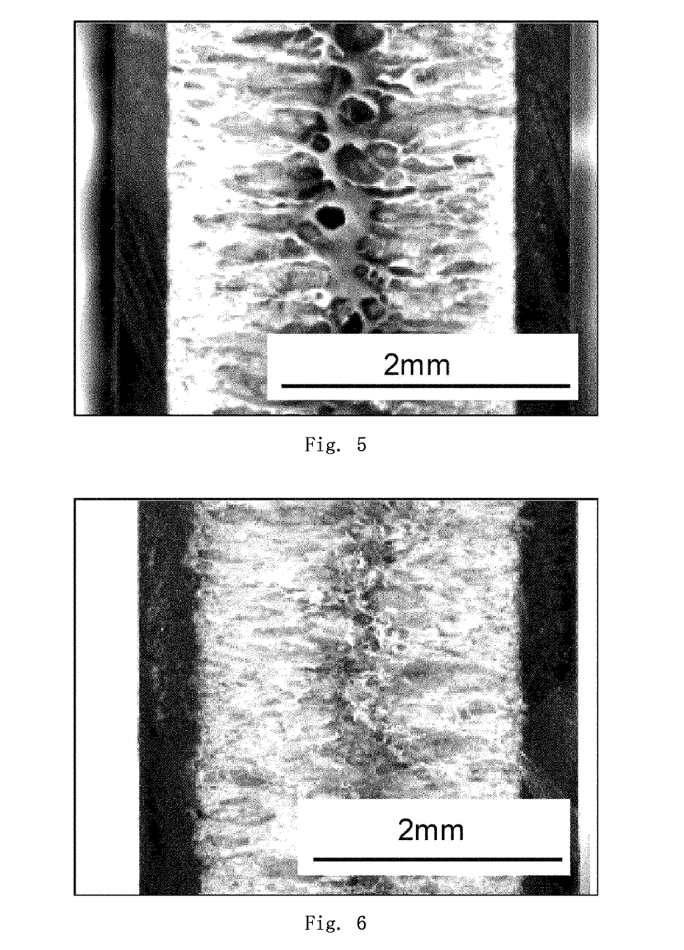

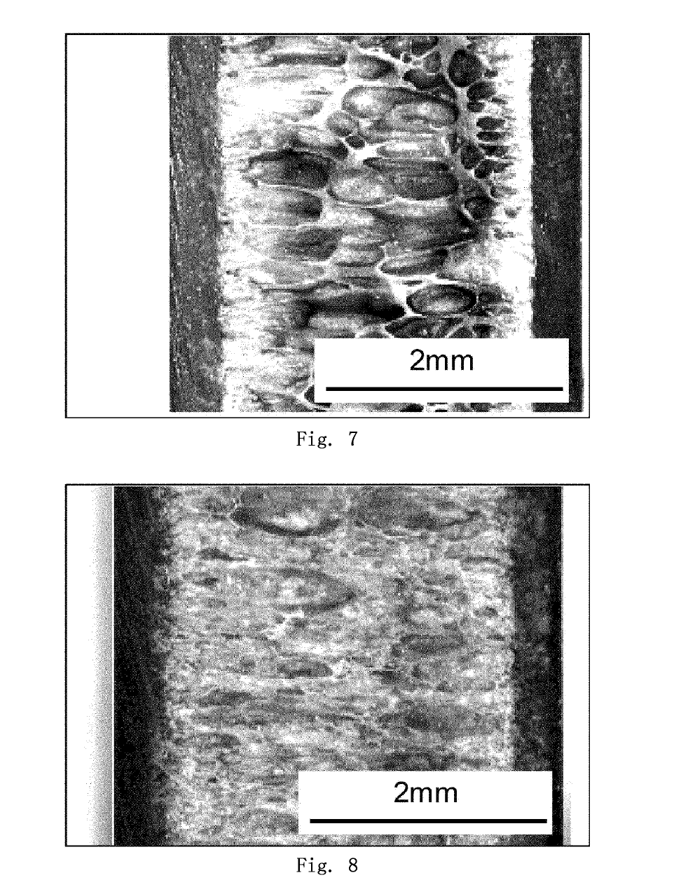

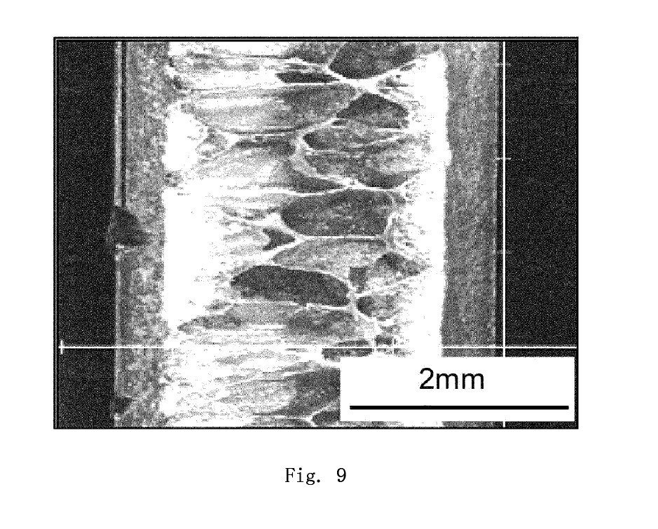

Evaluation results are given in Table 1 and optical microscope photographs of the cross sections of the obtained foam molded articles are shown in FIGS. 2 to 9. In Table 1, the incorporated amounts of the propylene polymer (A) and the ethylene-α-olefin copolymer (B) are expressed by rendering the total amount of the component (A) and the component (B) 100% by mass, and the incorporated amount of the component (C) is expressed by rendering the total amount of the propylene polymer (A) and the ethylene-α-olefin copolymer (B) 100 parts by mass.

TABLE 1

| | Composition | | | | | | |
|---|---|---|---|---|---|---|---|
| | A-1 | A-2 | A-3 | B | C | | Minuteness |
| | (% by | (% by | (% by | (% by | (part by | | of foamed |
| | mass) | mass) | mass) | mass) | mass) | MFR (g/10 min) | cells |
| Example 1 | 35.5 | 18.0 | 23.5 | 23.0 | C-1 | 46 | 5 |
| | | | | | 3.0 | | |
| Example 2 | 35.5 | 18.0 | 23.5 | 23.0 | C-2 | 53 | 4 |
| | | | | | 3.0 | | |
| Example 3 | 35.5 | 18.0 | 23.5 | 23.0 | C-3 | 43 | 4 |
| | | | | | 3.0 | | |
| Example 4 | 35.5 | 18.0 | 23.5 | 23.0 | C-4 | 55 | 3 |
| | | | | | 3.0 | | |
| Example 5 | 35.5 | 18.0 | 23.5 | 23.0 | C-5 | 61 | 3 |
| | | | | | 3.0 | | |
| Example 6 | 35.5 | 18.0 | 23.5 | 23.0 | C-6 | 54 | 2 |
| | | | | | 3.0 | | |
| Example 7 | 35.5 | 18.0 | 23.5 | 23.0 | C-7 | 52 | 3 |
| | | | | | 3.0 | | |
| Comparative | 35.5 | 18.0 | 23.5 | 23.0 | — | 62 | 1 |
| Example 1 | | | | | | | |

The methods for measuring physical properties of the resin components and the resin compositions used in the Examples and the Comparative Example are described below.

### (1) Melt Flow Rate (MFR)

Measurement was conducted in accordance with the method provided in JIS K7210.

For resin components other than the ethylene-α-olefin copolymer (B) and compositions, MFR was measured at 230° C. under a load of 2.16 kgf. For the ethylene-α-olefin copolymer (B), MFR was measured at 190° C. under a load of 2.16 kgf.

### (2) Structural Analysis of Propylene-Ethylene Block Copolymer

### (2-1) Intrinsic Viscosity of Propylene-Ethylene Block Copolymer

### (2-1-a) Intrinsic Viscosity of Propylene Homopolymer Component: [η]_{P}

In the production of a propylene-ethylene block copolymer, a propylene homopolymer was taken out from a polymerization vessel after the production of the propylene homopolymer. The intrinsic viscosity of the propylene homopolymer taken out was measured and it was represented by [η]_{P}.

### (2-1-b) Intrinsic Viscosity of Propylene-Ethylene Random Copolymer Component: [η]_{EP}

The intrinsic viscosity [η]_{P} of the propylene homopolymer component of a propylene-ethylene block copolymer and the intrinsic viscosity [η]_{T} of the entire portion of a propylene-ethylene block copolymer were measured, and then the intrinsic viscosity [η]_{EP} of the propylene-ethylene random copolymer component of the propylene-ethylene block copolymer was calculated from the following formula using the mass ratio X of the propylene-ethylene random copolymer component to the entire portion of the propylene-ethylene block copolymer.

[η]_{EP}=[η]_{T}/X−{(1/X)−1}[η]_{P}

[η]_{P}: Intrinsic viscosity (dl/g) of the propylene homopolymer component

[η]_{T}: Intrinsic viscosity (dl/g) of the entire portion of the propylene-ethylene block copolymer

### (2-1-c) Mass Ratio X of a Propylene-Ethylene Random Copolymer Component to the Entire Portion of a Propylene-Ethylene Block Copolymer

The mass ratio X of a propylene-ethylene random copolymer component to the entire portion of a propylene-ethylene block copolymer was determined by measuring the heat of crystal fusion of a propylene homopolymer component and that of the entire portion of the propylene-ethylene block copolymer and then calculating the ratio by using the following formula. The heat of crystal fusion was measured by differential scanning calorimetry (DSC).

X=1−(ΔHf)_{T}/(ΔHf)_{P}
(ΔHf)_{T}: heat of fusion (cal/g) of the entire portion of the block copolymer
(ΔHf)_{P}: Heat of fusion of the propylene homopolymer component (cal/g)

### (3) Ethylene Content (C2′)_{EP} of Propylene-Ethylene Random Copolymer Portion in Propylene-Ethylene Block Copolymer

The ethylene content (C2′)_{EP} of the propylene-ethylene random copolymer component of a propylene-ethylene block copolymer was determined by calculation using the following formula after measuring the ethylene content (C2′)_{T} of the entire portion of the propylene-ethylene block copolymer by an infrared absorption spectrum method.

(C2′)_{EP}=(C2′)_{T}/X

(C2′)_{T}: Ethylene content of the entire portion of the propylene-ethylene block copolymer (% by mass)

(C2′)_{EP}: Ethylene content of the propylene-ethylene random copolymer component (% by mass).

X: Mass ratio of the propylene-ethylene random copolymer component to the entire portion of the propylene-ethylene block copolymer

### (4) Cross Section Evaluation of a Foamed Article (Evaluation of the Minuteness of Foamed Cells)

The cell condition of a cross section (a portion 10 cm away from an injection gate) of a foam molded article obtained by foam molding was observed by an optical microscope, and the minuteness of foamed cells were judged on a five-graded scale. Grade 1 means that the minuteness of cells is the lowest (the cell density is the lowest) and grade 5 means that the minuteness of cells is the highest (the cell density is the highest).

Specific five-graded judgment criteria are as follows.
5: The cell diameter is uniform within a range of 10 to 100 μm, and breakage of cells, and the like are not found.
4: The cell diameter is uniform within a range of 100 to 300 μm, and the breakage of cells, and the like are not found.
3: The cell diameter is within a range of 100 to 500 μm, and the breakage of cells, and the like are not found.
2: Although the cell diameter is within the range of 100 to 500 μm, breakage of cells is found.
1: The cell diameter is very uneven within a range of 100 to 1,000 μm.

### INDUSTRIAL APPLICABILITY

According to the present invention, it is possible to obtain a resin composition from which a foam molded article having a uniform cell structure and being excellent in minuteness of foamed cells and thereby it becomes possible to obtain a foam molded article having a uniform cell structure and being excellent in minuteness of foamed cells.

1. A resin composition comprising a propylene polymer (A), an ethylene-α-olefin copolymer (B), and organic polymer beads (C), wherein the proportion of the amount of the propylene polymer (A) and the proportion of the amount of the ethylene-α-olefin copolymer (B) relative to the sum total of the amounts of the propylene polymer (A) and the ethylene-α-olefin copolymer (B) are 40 to 95% by mass and 5 to 60% by mass, respectively, the amount of the organic polymer beads (C) for 100 parts by weight in total of the propylene polymer (A) and the ethylene-α-olefin copolymer (B) is 0.1 to 20 parts by weight, and the density of the ethylene-α-olefin copolymer (B) is 0.85 to 0.89 g/cm³.

2. The resin composition according to claim 1 which further comprises 0.1 to 60 parts by mass, for 100 parts by mass in total of the propylene polymer (A) and the ethylene-α-olefin copolymer (B), of an inorganic filler (D).

3. The resin composition according to claim 1 which has a melt flow rate, as measured at 230° C. under a load of 2.16 kgf in accordance with JIS K7210, of 40 to 200 g/10 min.

4. A foam molded article comprising the resin composition according to claim 1.
